(19) United States
(12) Patent Application Publication
(10) Pub. No.: US 2026/0030461 A1
(43) Pub. Date: Jan. 29, 2026

(54) COMPUTING TECHNOLOGIES FOR USING LANGUAGE MODELS TO CONVERT TEXTS BASED ON PERSONAS

(71) Applicant: Smartling, Inc., New York, NY (US)

(72) Inventors: Mei Chai Zheng, Secaucus, NJ (US); Benjamin Loy, New York, NY (US); Jennifer Wong, New York, NY (US)

(21) Appl. No.: 19/342,041

(22) Filed: Sep. 26, 2025

Related U.S. Application Data
(63) Continuation of application No. PCT/US2024/034778, filed on Jun. 20, 2024.
(60) Provisional application No. 63/521,978, filed on Jun. 20, 2023.

(51) Int. Cl. G06F 40/58

(52) U.S. Cl. CPC G06F 40/58

(57) ABSTRACT

This disclosure solves various technological problems described above by using language models (LMs) (e.g., large, small) to convert (e.g., translate, augment, adapt) texts for targeted demographics based on personas. Such improvements may be manifested by various outputs following specific descriptive attributes and stylistic preferences. Resultantly, these improvements improve computer functionality and text processing by enabling at least some conversions of texts for specific speakers, audiences, or contexts. These technologies ensure that translations are not only accurate in terms of semantic meaning of texts but also appropriate in terms of speakers, audiences, or contexts.

### CROSS-REFERENCE TO RELATED PATENT APPLICATIONS

This patent application is a Continuation of PCT International Application PCT/US2024/034778 filed 20 Jun. 2024; which claims a benefit of priority to U.S. Provisional Patent Application 63/521,978 filed 20 Jun. 2023; each of which is incorporated by reference herein for all purposes.

### TECHNICAL FIELD

This disclosure relates to Language Models.

### BACKGROUND

Conventionally, some Machine Translation (MT) engines deploy generic MT models to create generic machine translations (e.g., from Russian language to English language). Therefore, style and voice in such translations may be significantly restricted and heavily skewed by certain datasets on which the MT models were trained, because these datasets may contain certain linguistic biases and input parameters (e.g., glossary and formality) that may be used to generate such translations. Resultantly, these MT engines may be unable to take in freeform contents or additional input parameters that may control corresponding translation processes to reach human levels of consistency and quality for translations for specific audiences. For example, such MT engines may be unable to hyper-localize translations with specific focus on different speaker personas or audience personas. Further, such MT engines may not be programmed to enable laymen to create target content based on user profiles. Additionally, such MT engines may not correctly or consistently output translations with specific tones, especially when translating large amounts of content that have been separated into smaller chunks, such as individual segments, where at least some usage of tone and style may be inconsistent or unpredictable. These technical deficiencies may be further exacerbated by multitudes of inherent grammatical properties of languages. For example, some languages may be structurally dependent on registers (e.g., formality versus informality where a variety of language may be used for a particular purpose or in a particular communicative situation) which may affect entire sentences, and not only pronouns, adjectives and verbs. Also, some languages may rely on certain uses of linguistic nuances to determine tones of voice, which may affect some syntaxes of some sentences or some style of communication. Consequently, there may be no known universal way to ensure that these MT engines can output translations that are consistent in terms of business-audience communication styles, especially when colloquial expressions, idioms, or proverbs may contain different characteristics or are utilized differently from each other.

### SUMMARY

This disclosure solves various technological problems described above by using Language Models (LMs) (e.g., large, small) to convert (e.g., translate, augment, adapt) texts for targeted demographics based on personas. Such improvements may be manifested by various outputs following specific descriptive attributes and stylistic preferences. Resultantly, these improvements improve computer functionality and text processing by enabling at least some conversions of texts for specific speakers, audiences, or contexts. These technologies ensure that translations are not only accurate in terms of semantic meaning of texts, but also appropriate in terms of speakers, audiences, or contexts.

There may be an embodiment comprising a system programmed as described herein. For example, the system may comprise: a computing instance programmed to: store a persona, a descriptive attribute for the persona, and a stylistic preference for the persona; receive a request from a computing terminal, wherein the request requests a conversion of a first text recited in a first language for a first region identifier to a second text recited in a second language for a second region identifier; generate a prompt based on the persona, the descriptive attribute, and the stylistic preference to perform the conversion of the first text recited in the first language for the first region identifier to the second text recited in the second language for the second region identifier; input the prompt into a LM such that the LM generates an output containing the second text recited in the second language for the second region identifier; attempt to validate the output;
and take a first action responsive to the request based on the output being validated or a second action responsive to the request based on the output not being validated.

There may be an embodiment comprising a method programmed as described herein. For example, the method may comprise: storing, via a computing instance, a persona, a descriptive attribute for the persona, and a stylistic preference for the persona; receiving, via the computing instance, a request from a computing terminal, wherein the request requests a conversion of a first text recited in a first language for a first region identifier to a second text recited in a second language for a second region identifier; generating, via the computing instance, a prompt based on the persona, the descriptive attribute, and the stylistic preference to perform the conversion of the first text recited in the first language for the first region identifier to the second text recited in the second language for the second region identifier; inputting, via the computing instance, the prompt into a LM such that the LM generates an output containing the second text recited in the second language for the second region identifier; attempting, via the computing instance, to validate the output; and taking, via the computing instance, a first action responsive to the request based on the output being validated or a second action responsive to the request based on the output not being validated.

There may be an embodiment comprising a storage medium programmed as described herein. For example, the storage medium may store a set of instructions executable by a computing instance to perform a method, wherein the method may comprise: storing, via a computing instance, a persona, a descriptive attribute for the persona, and a stylistic preference for the persona; receiving, via the computing instance, a request from a computing terminal, wherein the request requests a conversion of a first text recited in a first language for a first region identifier to a second text recited in a second language for a second region identifier; generating, via the computing instance, a prompt based on the persona, the descriptive attribute, and the stylistic preference to perform the conversion of the first text recited in the first language for the first region identifier to the second text recited in the second language for the second region identifier; inputting, via the computing instance, the prompt into a LM such that the LM generates an output containing the second text recited in the second language for the second region identifier; attempting, via the computing instance, to validate the output; and taking, via the computing instance, a first action responsive to the request based on the output being validated or a second action responsive to the request based on the output not being validated.

There may be an embodiment comprising a system programmed as described herein. For example, the system may comprise: a computing instance programmed to: store a persona, a descriptive attribute for the persona, and a stylistic preference for the persona; receive a request from a data source, wherein the request requests a conversion of a first text recited in a first language for a first region identifier to a second text recited in a second language for a second region identifier; generate a prompt based on the persona, the descriptive attribute, and the stylistic preference to perform the conversion of the first text recited in the first language for the first region identifier to the second text recited in the second language for the second region identifier; input the prompt into a LM such that the LM generates an output containing the second text recited in the second language for the second region identifier; attempt to validate the output; and take a first action responsive to the request based on the output being validated or a second action responsive to the request based on the output not being validated.

### DESCRIPTION OF DRAWINGS

FIG. 1 shows a diagram of an embodiment of a computing architecture according to this disclosure.

FIG. 2 shows a flowchart of an embodiment of an algorithm for a conversion of a text according to this disclosure.

FIG. 3 shows a diagram of an embodiment of a top level schema according to this disclosure.

FIG. 4 shows a diagram of an embodiment of a prompt schema according to this disclosure.

FIG. 5 shows a diagram of an embodiment of a result according to this disclosure.

### DETAILED DESCRIPTION

As explained above, this disclosure solves various technological problems described above by using LMs (e.g., large, small) to convert (e.g., translate, augment, adapt) texts for targeted demographics based on personas. Such improvements may be manifested by various outputs following specific descriptive attributes and stylistic preferences. Resultantly, these improvements improve computer functionality and text processing by enabling at least some conversions of texts for specific speakers, audiences, or contexts. These technologies ensure that translations are not only accurate in terms of semantic meaning of texts, but also appropriate in terms of speakers, audiences, or contexts.

This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

As used herein, a term “locale” refers to a standard language locale definition but where a language identifier (e.g., en, es) is required and a region identifier (e.g., US, ES) is optional.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have the same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

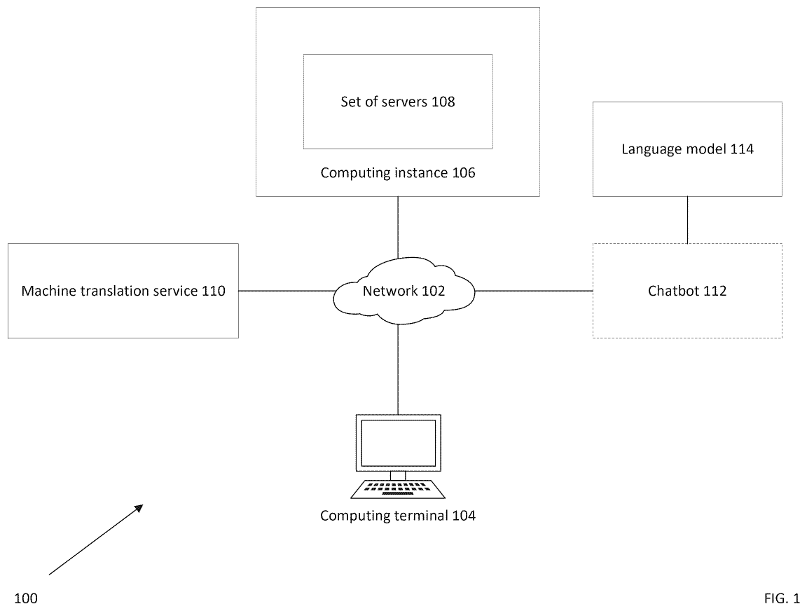

FIG. 1 shows a diagram of an embodiment of a computing architecture according to this disclosure. In particular, there is a computing architecture 100 containing a network 102, a computing terminal 104, a computing instance 106, an MT service 110, a chatbot 112, and a LM 114. The computing instance 106 contains a server or set of servers 108. The chatbot 112 is optional and may be omitted.

The network 102 is a wide area network (WAN), but may be a local area network (LAN), a cellular network, a satellite network, or any other suitable network. For example, the network 102 is Internet. Although the network 102 is illustrated as a single network 102, this configuration is not required and the network 102 can be a group or collection of suitable networks collectively operating together in concert to accomplish various functionality, as disclosed herein.

The computing terminal 104 is a desktop computer, but may be a laptop computer, a tablet computer, a wearable computer, a smartphone, or any other suitable computing form factor. The computing terminal 104 hosts an operating system (OS) and an application program on the OS. For example, the OS may include Windows, MacOS, Linux, or any other suitable OS. Likewise, the application program may be a browser program (e.g., Microsoft Edge, Apple Safari, Mozilla Firefox), an enterprise content management (ECM) program, a content management system (CMS) program, a customer relationship management (CRM) program, a marketing automation platform (MAP) program, a product information management (PIM) program, or a translation management system (TMS) program, or any other suitable application, which is operable (e.g., interactable, navigable) by a user of the computing terminal 104. The computing terminal 104 may be in communication (e.g., wired, wireless, waveguide) with the computing instance 106, the MT service 110, the chatbot 112, or the LM 114 over the network 102. For example, such communication may occur via the application program running on the OS, as explained above. The computing terminal 104 is separate and distinct from the computing instance 106, the MT service 110, the chatbot 112, or the LM 114.

Note that a data source (e.g., a server, a physical server, a virtual server, an application program, an Application Programming Interface (API)) may operate as the computing terminal 104, whether alternative or additional to the computing terminal 104 (e.g., also in communication with the network 102). As such, various references to the computing terminal 104 are applicable to the data source or vice versa.

The computing instance 106 is a computing service or unit containing the server (e.g., physical or virtual) or the set of servers 108 (e.g., physical or virtual) programmatically acting in concert, any of which may be a web server, an application server, a database server, or another suitable server, to enable various algorithms disclosed herein. For example, via the server or the set of servers 108, the computing instance 106 may be enabled in a cloud computing service (e.g., Amazon Web Services (AWS)) as a service-oriented-architecture (SOA) backend technology stack having a plurality of services that are interconnected via various APIs, to enable various algorithms disclosed herein, any of which may be internal (e.g., for maintenance purposes) or external (e.g., for modularity purposes) to the computing instance 106. For example, some of such APIs may have, call, or instantiate representational state transfer (REST) or RESTful APIs integrations or some of services may have, instantiate, or call some data sources (e.g., databases, relational databases, database services, relational database services, graph databases, in-memory databases, RDS, S3, Kafka) to persist data, as needed, whether internal (e.g., for maintenance purposes) or external (e.g., for modularity purposes) to the computing instance 106, to enable various algorithms disclosed herein. For example, the computing instance 106 may host or run an application program, which may be distributed, on the SOA hosting, deploying, calling, or accessing the services that are interconnected via the APIs, to enable various algorithms disclosed herein. For example, the computing instance 106 (e.g., an application program) may have, host, call, or instantiate a persona selection service, whether internal (e.g., for maintenance purposes) or external (e.g., for modularity purposes) to the computing instance 106, to enable various algorithms disclosed herein. For example, the persona selection service may have, host, call, or instantiate a cloud service, whether internal (e.g., for maintenance purposes) or external (e.g., for modularity purposes) to the computing instance 106, that has a database (e.g., relational, graph, in-memory, NoSQL), whether internal (e.g., for maintenance purposes) or external (e.g., for modularity purposes) to the computing instance 106, containing a set of personas selectable for a set of users requesting conversions (e.g., translations, augmentations, adaptations), whether internal (e.g., for maintenance purposes) or external (e.g., for modularity purposes) to the computing instance 106, to enable various algorithms disclosed herein. The cloud service may have a number of REST APIs to execute create, update, read, and delete (CRUD) operations to maintain the database and a number of other APIs to do tasks involving taking a first text (e.g., unstructured, structured) and returning a second text (e.g., unstructured, structured) being converted (e.g., translated, augmented, adapted) from the first text, as disclosed herein. The persona selection service may include a set of persona style guide unique identifiers (UIDs) to partition certain persona style guides into different content groups that can be accessed independently of each other, to enable various algorithms disclosed herein. For example, the computing instance 106 may use the set of persona style guide UIDs to determine which style guide data structures (e.g., a database, a record, a field, a row, a column, a table, an array, a tree, a graph, a file, a data file, a text file) to use for conversion (e.g., translation, augmentation, adaptation) of the first text to the second text, as disclosed herein. The computing instance 106 may be in communication (e.g., wired, wireless, waveguide) with the computing terminal 104, the MT service 110, the chatbot 112, or the LM 114 over the network 102. For example, such communication may occur via the SOA backend technology stack or a persona style guide service (e.g., instructions for expected personas and prompts), as explained above. For example, the computing instance 106 may have, host, call, or instantiate the persona style guide service. The computing instance 106 is separate and distinct from the computing terminal 104, the MT service 110, the chatbot 112, or the LM 114. However, such configurations may vary. For example, the computing instance 106 may internally host the MT service 110, the chatbot 112, or the LM 114.

The computing instance 106 may be hosted within a data center. For example, the data center may be a building, a dedicated space within a building, or a group of buildings having a suitable computing infrastructure (e.g., an item of networking equipment) communicating (e.g., wired, wireless, waveguide) with the network 102 and enabling the computing instance 106 to operate, as disclosed herein.

The MT service 110 is a network-based MT service that instantly translates words, phrases, and web pages between at least two languages (e.g., English and Hebrew). For example, the MT service 110 may be running on a server or a set of servers (e.g., physical or virtual) acting in concern to host an MT engine (e.g., a task-dedicated executable logic that can be started, stopped, or paused) having a Neural Machine Translation (NMT) logic. For example, the MT service 110 may be Google Translate, Bing Translator, Yandex Translate, or another suitable network-based MT service. The MT service 110 may be in communication (e.g., wired, wireless, waveguide) with the computing terminal 104, the computing instance 106, the chatbot 112, or the LM 114 over the network 102. For example, such communication may occur via the MT engine, as explained above. The MT service 110 is separate and distinct from the computing terminal 104, the computing instance 106, the chatbot 112, or the LM 114. However, such configurations may vary. For example, the MT service 110 may internally host the computing instance 106, the chatbot 112, or the LM 114.

The chatbot 112 is a computer program that simulates human conversation, allowing interaction through text or voice. The chatbot 112 can handle various tasks, which may range from answering customer queries to providing support or automating processes. The chatbot 112 can be a scripted or quick reply chatbot, a keyword recognition-based chatbot, a hybrid chatbot, a contextual chatbot, a voice chatbot, or another suitable chatbot form factor. For example, the chatbot 112 may be ChatGPT, Google Gemini/Bard, Microsoft Copilot, or another suitable chatbot. The chatbot 112 may be in communication (e.g., wired, wireless, waveguide) with the computing terminal 104, the computing instance 106, the MT service 110, or the LM 114 over the network 102. The chatbot 112 is separate and distinct from the computing terminal 104, the computing instance 106, the MT service 110, or the LM 114. However, such configurations may vary. For example, the chatbot 112 may directly communicate with the LM 114 or internally host the LM 114, to be operated thereby. Alternatively, the LM 114 may directly communicate with the chatbot 112 or internally host the chatbot 112, to enable the chatbot 112 to be operated thereby. Additionally, the computing terminal 104, the computing instance 106, or the MT service 110 may internally host the chatbot 112, whether the chatbot 112 is separate and distinct from the LM 114 or not, as explained above. Note that the chatbot 112 is optional and may be omitted.

The LM 114 may be a language model (e.g., a generative artificial intelligence (AI) model, a generative adversarial network (GAN) model, a generative pre-trained transformer (GPT) model) including an artificial neural network (ANN) with a set of parameters (e.g., tens of weight, hundreds of weights, thousands of weights, millions of weights, billions of weights, trillions of weights), initially trained on a quantity of unlabeled content (e.g., text, unstructured text, descriptive text, imagery, sounds) using a self-supervised learning algorithm or a semi-supervised learning algorithm or an unsupervised learning algorithm to understand a set of corresponding data relationships. Then, the LM 114 may be further trained by fine-tuning or refining the set of corresponding data relationships via a supervised learning algorithm or a reinforcement learning algorithm. For example, the LM 114 may be trained using causal language modeling or autoregressive language modeling, which may enable the LM 114 to employ a causal or an autoregressive approach to predict a next token in a sequence given a set previous tokens. For example, the LM 114 may be a unidirectional model, attending to context (e.g., tokens) before prediction. For example, the LM 114 may be a GPT-3 model, a GPT-4 model, a PaLM-2 model, or another suitable LM. For example, the LM 114 may be not a masked LM.

Once the LM 114 is trained, the LM 114 is structured to have a data structure and organized to have a data organization. As such, the data structure and the data organization collectively enable the LM 114 to perform various algorithms disclosed herein. For example, the LM 114 may be a general purpose model, which may excel at a range of tasks (e.g., generating a content for a user consumption) and may be prompted, i.e., programmed to receive a prompt (e.g. a request, a command, a query), to do something or accomplish a certain task. The LM 114 may be embodied as or accessible via a ChatGPT AI chatbot, a Google Gemini/Bard AI chatbot, Microsoft Copilot AI chatbot, or another suitable LM. The LM 114 may be prompted by the computing terminal 104, the computing instance 106, or the MT service 110, whether directly or indirectly. For example, the computing instance 106 may be programmed to engage with the LM 114 over the network 102, whether through the chatbot 112 or without the chatbot 112, to perform various algorithms disclosed herein. Alternatively, the computing instance 106 may internally host the LM 114 and programmed to engage with the LM 114, to perform various algorithms disclosed herein. Such forms of engagement may include inputting a text (e.g., structured or unstructured) into the LM 114 in a human-readable form, for the LM 114 to output a content (e.g., a text, a structured text, an unstructured text, a descriptive text, an image, a sound), i.e., to do something or accomplish a certain task. Note that the LM 114 can be scaled down into a small LM (SLM) or the SLM can be a miniatured or less complex version of the LM 114, which can trained on less data and fewer parameters than the LM 114. As such, various algorithms disclosed herein can use the SLM as the LM 114, as disclosed herein.

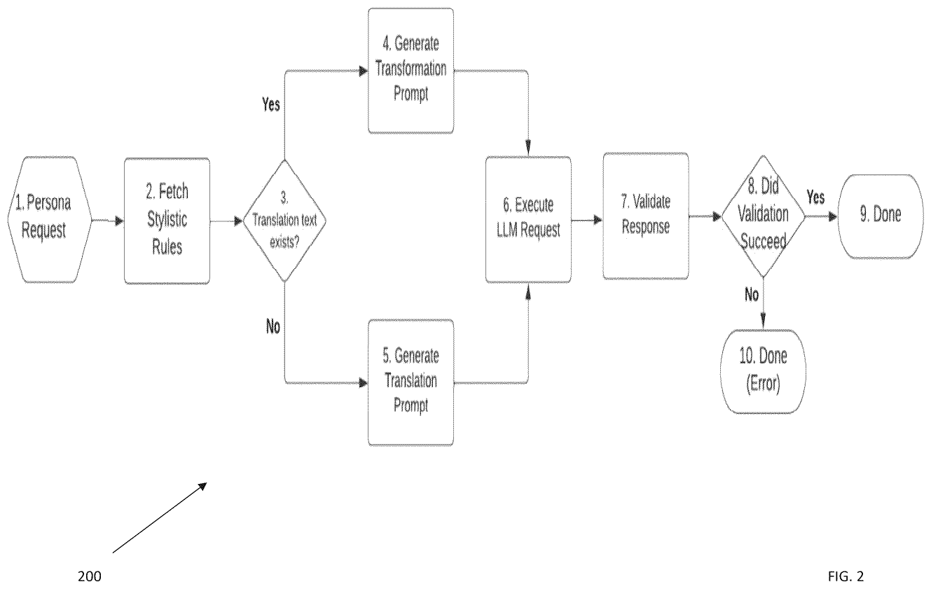

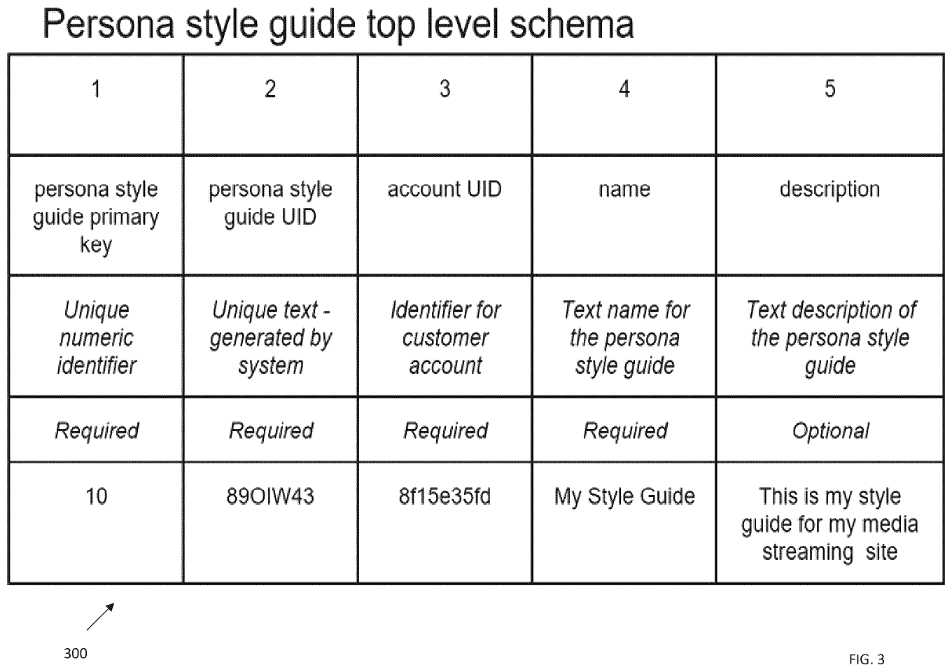

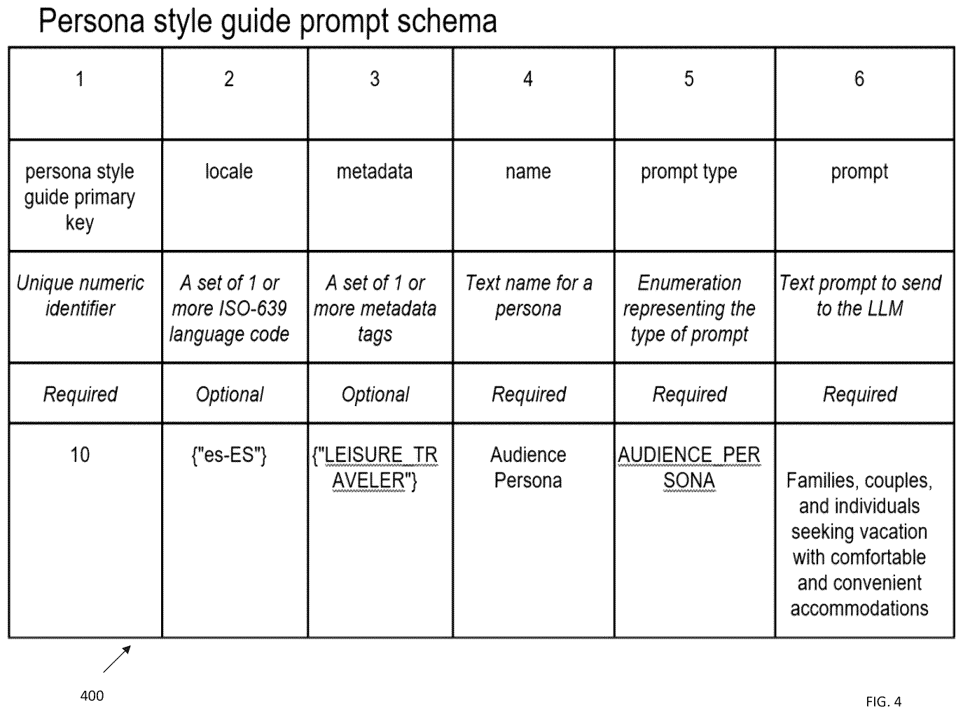

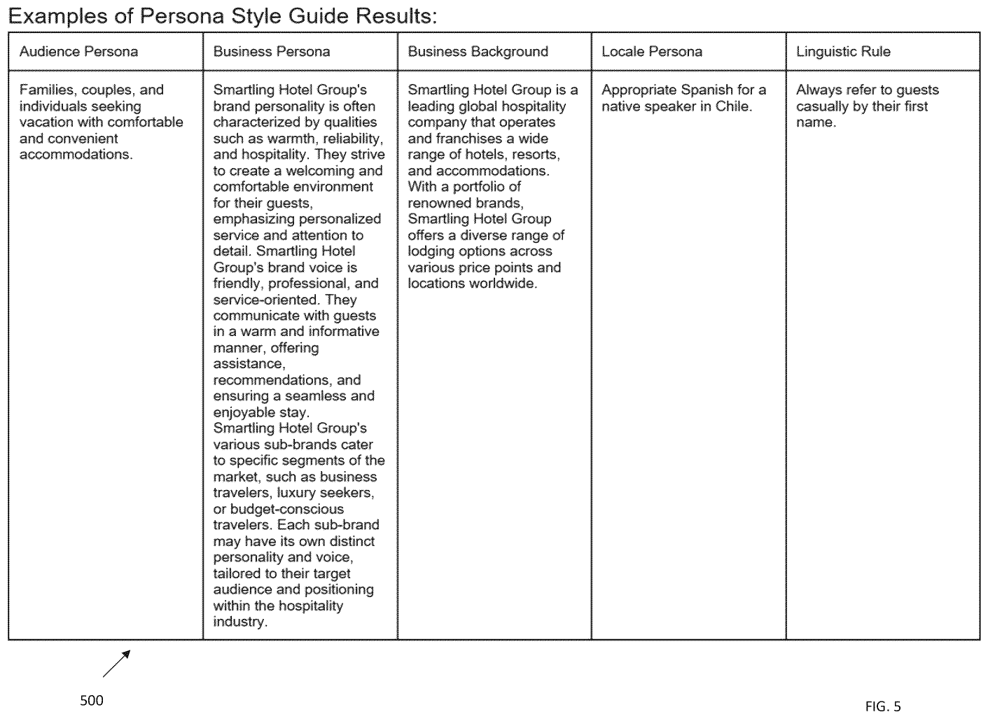

FIG. 2 shows a flowchart of an embodiment of an algorithm for a conversion of a text according to this disclosure. FIG. 3 shows a diagram of an embodiment of a top level schema according to this disclosure. FIG. 4 shows a diagram of an embodiment of a prompt schema according to this disclosure. FIG. 5 shows a diagram of an embodiment of a result according to this disclosure.

In particular, there is a method 200 shown in FIG. 2 for enabling a conversion (e.g., a translation, an augmentation, an adaption) of a text using the computing architecture 100 shown in FIG. 1, a top level schema 300 shown in FIG. 3, and a prompt schema 400 shown in FIG. 4, to collectively enable a result 500 shown in FIG. 5. The method 200 has steps 1-9, which may be performed by the computing instance 106 (e.g., an application program). The method 200, the top level schema 300, the prompt schema 400, and the result 500 enable usage of LMs (e.g., large, small) to convert (e.g., translate, augment, adapt) texts for targeted demographics based on personas. Such improvements may be manifested by various outputs following specific descriptive attributes and stylistic preferences. Resultantly, these improvements improve computer functionality and text processing by enabling at least some conversions of texts for specific speakers, audiences, or contexts. These technologies ensure that translations are not only accurate in terms of semantic meaning of texts, but also appropriate in terms of speakers, audiences, or contexts. For example, the computing instance 106 may be programmed to enable a text (e.g., an alphanumeric string) to follow a stylistic guideline for a persona associated with a descriptive attribute and a stylistic preference, where such following may be needed in a formal translation. As such, the computing instance 106 may send the text to the LM 114 via a prompt generated based on the text, the persona, the descriptive attribute, and the stylistic preference, such that the LM 114 outputs a translation, an augmentation, or an adaption of the text that accounts for the persona, the descriptive attribute, and the stylistic preference, as disclosed herein.

Step 1 involves the computing instance 106 receiving a persona request from the computing terminal 104 over the network 102. The persona request may include a source text, a source locale identifier (ID), a target locale ID, a set of LM provider credentials and metadata, and a persona style guide user ID (UID). The persona request may include a set of metadata tags, which may provide corresponding descriptive information (e.g., a textual description, an identifier, or an abbreviation of a persona style guide) or include user defined metadata tags in a text format to associate with specific LM prompts. For example, a hotel chain may define LEISURE_TRAVELER and BUSINESS_TRAVELER to determine which audience, leisure or business, a specific hotel is advertising towards.

The source text (e.g., alphanumeric string) may be already translated and obtained by the computing instance 106 from a data source (e.g., an API, an email message, a server, a File Transfer Protocol (FTP) site, the computing terminal 104, a file sharing service) external to the computing instance 106 to be augmented or adapted, as disclosed herein, or the source text may need to be translated, as disclosed herein, which may further include augmentation or adaptation, as disclosed herein. The source text may be structured, such as a JavaScript Objection Notation (JSON) content, an extensible Markup Language (XML) content, a Darwin Information Typing Architecture (DITA) content, or another suitable structured content. For example, the source text may include an alphanumeric string which may include a phrase, a sentence, an unstructured text, a descriptive text, a structured text, or another suitable text form factor.

The source text may be unstructured, such as descriptive content, natural language content, or any other suitable unstructured content. For example, when the source text is unstructured, the source text may include a descriptive text (e.g., an article, a legal document, a patent specification) contained in a data structure (e.g., a file, a data file, a text file, an email message). For example, the source text may be in a string, which may be a sentence or another suitable linguistic form factor (e.g., a set of sentences, a paragraph).

The source locale ID may be a modified ISO-639 (or another standard) language code (e.g., en, es) and a modified ISO-3166 country code (e.g., US, ES) representing a source text locale (e.g., ru-RU or es-MX). The target locale ID may be a modified ISO-639 (or another standard) language code (e.g., en, es) and a modified ISO-3166 country code (e.g., US, US) representing a desired locale to use for translation (e.g., en-US or es-MX). For example, locale may include language and regional information, (e.g., Spanish for Mexico (es-MX)) or source/locale ID may include an ISO code to define and determine a locale (e.g., an ISO 639-1 code).

The set of LM provider credentials and metadata may include a name, which may include a version, of an LM service provider to use (e.g., GPT-40, PaLM-2, Mistral) by the computing instance 106. For example, the name of the LM service provider may be identified by an identifier (e.g., an alphanumeric string, a Uniform Resource Locator (URL)). The set of LM provider credentials and metadata may include a set of LM service provider specific credentials to interact with the LM service provider (e.g., a login and a password). The set of LM provider credentials and metadata may include a set of LM service provider specific metadata and parameters to control various aspects of a conversion (e.g., a translation, an augmentation, an adaptation) process (e.g., a custom model, a temperature). For example, the LM 114 may be an LLM engine or model, such as GPT-3, GPT-4, PaLM-2, or others, where the LLM engine may be a task-dedicated computing program that may be started, paused, or stopped. The engine may be hosted on the computing instance 106 or off the computing instance 106 for access by the computing instance 106, as disclosed herein. The LM provider may be an entity (e.g., a network-based data source) that supply or provide access (e.g., credentialed) to a language model (e.g., large, small) via an API. For example, the LM provider may be trained engines deployed by companies, such as OpenAI, Google, Smartling, or others. The set of LM provider credentials and metadata may allow an input of a prompt into the LM 114, where the prompt may be text (or another form of suitable content) given to the LM 114 as instructions for next actions.

The persona style guide UID may be used by the computing instance 106 to determine which persona style guide data structures (e.g., a database, a table, a record, a field, an array, a tree, a graph) to use by the computing instance 106 to inform of or request a conversion (e.g., translation, augmentation, adaptation) style. For example, one persona style guide data structure may be for Spanish and another persona style guide data structure may be for Hebrew. For example, one persona style guide data structure may be for one type of content (e.g., industry, formality, marketing, life science, computing, legal, family friendly, causal) and another persona style guide data structure may be for another type of content (e.g., industry, formality, marketing, life science, computing, legal, family friendly, causal).

As shown in FIG. 3, the top level schema 300 is an example of a persona style guide data structure (e.g., a database, a table, a record, a field, an array, a tree, a graph) showing a set of top level objects defining a persona style guide used in the method 200. The top level schema 300 has a persona style guide primary key, a persona style guide UID, an account UID, a name, and a description, where the persona style guide primary key relates the persona style guide UID, the account UID, the name, and the description to form one data record.

The persona style guide primary key may be generated by the computing instance 106 and may include an alphanumeric string. The persona style guide UID may be a unique identifier generated by the computing instance 106 to identify a persona style guide and may include an alphanumeric string. The account UID may be a unique identifier generated by the computing instance 106 to identify a customer account associated with the persona style guide UID and may include an alphanumeric string, which may be relevant for a software-based translation service. The name may be an identifier, which may be an alphanumeric string generated by the user operating the computing terminal 104 over the network 102 or by the computing instance 106, to identify a persona style guide when displayed in a graphical user interface (GUI) on the computing terminal 104 over the network 102. The description may be a textual description, which may be an alphanumeric string generated by the user operating the computing terminal 104 over the network 102 or by the computing instance 106, to identify a use-case for a persona style guide.

As shown in FIG. 4, the prompt schema 400 is an example of a persona style guide data structure (e.g., a database, a table, a record, a field, an array, a tree, a graph) showing 0 to n rows of data that a persona style guide will contain and a set of relevant fields used in the method 200, together with the top level schema 300. The prompt schema 400 has a persona style guide primary key, a locale identifier, a metadata information, a name, a type of a prompt, and a prompt, where the persona style guide primary key relates the locale identifier, the metadata tag, the name, the type of the prompt, and the prompt to form one data record.

The persona style guide primary key of the prompt schema 400 corresponds to the persona style guide primary key of the top level schema 300 (e.g., same primary key). For example, the persona style guide primary key of the prompt schema 400 is a foreign key to the primary key of the top level schema 300. The prompt schema 400 has a many-to-one cardinality or correspondence with the top level schema 300. The local identifier may identify a locale in which this persona style guide should apply to or null to apply to all persona style guides regardless of locale, which may be input by the user of the computing terminal 104 over the network 102 or generated by the computing instance 106. The metadata information may include a metadata tag in which this persona style guide should apply to or null to apply to all persona style guides regardless of metadata, which may be input by the user of the computing terminal 104 over the network 102 or generated by the computing instance 106. The name may be a user-generated name from the computing terminal 104 over the network 102 to identify the prompt. The type of the prompt may be an enumeration of potential types of prompts, which may be added, edited, or removed from the computing terminal 104 over the network 102. For example, the type of prompt may be AUDIENCE_PERSONA, BUSINESS_PERSONA, LOCALE_PERSONA, BUSINESS_BACKGROUND, LINGUISTIC_RULE, or another suitable prompt, in this format or another suitable format. For example, the BUSINESS_BACKGROUND may be identifying information (e.g., textual, alphanumeric) disclosing general information about a business entity, such as a location identifier, an industry identifier, a size identifier, a blurb about a company (or another form of organization), or another suitable identifying information. For example, the BUSINESS_PERSONA may be a business user profile containing a description of characteristics of how a respective business would like to be perceived by its audiences from its communication, such as a perception identifier, a brand voice, tone & style identifier, content type identifier, a language identifier, or another suitable characteristic. For example, the AUDIENCE_PERSONA may be an audience user profile containing a description of characteristics of a person that may be loosely related to demographics of the person, such as a locale persona (pulled from a target locale) identifier, a language (optional) identifier, a location (optional) identifier, an age range identifier, an income range/status identifier, a profession identifier, an education level identifier, a reading level identifier, an interests identifier, a characteristics identifier, or another suitable characteristic. For example, the LOCALE_PERSONA may be a locale user profile containing a general description of characteristics of a specific locale where an audience member resides, set based on a target locale and used to augment the AUDIENCE_PERSONA. For example, the linguistic rule (or preference) may include a freeform rule or preference to specify more complex stylistic prompts. For example, the type of prompt may be a business-audience communication style which may indicate a content indicative of a style of communication expected based on the BUSINESS_PERSONA and the AUDIENCE_PERSONA, where such content may include a text, a phrase, a sentence, an unstructured text, a descriptive text, a structured text, or another suitable form of content. The type of prompt may be input by the user of the computing terminal 104 over the network 102 or generated by the computing instance 106. The prompt may be an alphanumeric string descripting an input to use in the LM 114 associated with this persona style guide, as disclosed herein.

Step 2 involves the computing instance 106 fetching (e.g., retrieving, accessing) a set of stylistic rules (or preferences), or a copy thereof, in response to the computing instance 106 receiving the persona request from the computing terminal 104 over the network 102. This fetching may occur by the computing instance 106 making a call to an API (e.g., a REST API) to the persona style guide service with the source text (which may be omitted from the call), the source locale ID, the target locale ID, the metadata information, and the set of persona style guide UIDs (e.g., one UID for source or speaker persona style guide data structure and one UID for target or audience persona style guide data structure). The API can be internal to the computing instance 106, which avoids using the network 102 (e.g., for speed) or external to the computing instance 106, which uses the network 102 (e.g., for modularity).

In reply to the computing instance 106 making the call, the API outputs an output (e.g., a message) to the computing instance 106, where the output contains at least: zero or more audience persona prompts if available for the target locale ID, zero or more business persona prompts if available for the target locale ID, zero or more business background prompts if available for the target locale ID, zero or more locale persona prompts if available for the target locale ID, or zero or more linguistic rule prompts if available for the target locale ID. For example, the result 500 shown in FIG. 5 embodies one example of the output the computing instance 106 receives from the API. In case of an error with the call to the API, the method 200 continues with no persona style guides. As such, for example, the computing instance 106 may be programmed to store a persona (e.g., a speaker or source profile or a target or audience profile), a descriptive attribute (e.g., an indicator that a content item is for a hotel chain (or something else) as a domain and for a marketing page as a content type) for the persona, and a stylistic preference (e.g., a casual style) for the persona, where the persona, the descriptive attribute, or the stylistic preference may be created by the user operating the computing terminal 104 interfacing with the computing instance 106 over the network 102. The computing instance 106 may receive a request (e.g., a persona request) from the computing terminal 104 (or a data source referenced above), where the request requests a conversion (e.g., translation, augmentation, adaptation) of a first text (e.g., an article) recited in a first language (e.g., English) for a first region (e.g., Australia) identifier to a second text (e.g., an article) recited in a second language (e.g., Spanish) for a second region identifier (e.g., Mexico). The persona may internally store the descriptive attribute or the stylistic preference (e.g., for speed) or the descriptive attribute or the stylistic preference may be stored external to the persona (e.g., for modularity). The first text (e.g., the source text) may be an unstructured text or a structured text. The first language and the second language may be one language (e.g., English) or different languages (e.g., Arabic and Spanish). The first region identifier and the second region identifier may be one region identifier (e.g., US) or different region identifiers (e.g., Spain and Mexico). The conversion may include a translation of the first text recited in the first language for the first region identifier to the second text recited in the second language for the second region identifier. The conversion may include an augmentation or an adaptation of the first text recited in the first language for the first region identifier to the second text recited in the second language for the second region identifier.

Step 3 involves the computing instance 106 determining whether the source text, which was received in Step 1 of the method 200, is translated or in need of translation, responsive to the computing instance 106 receiving the output from the API. This determination may occur based on the user operating the computing terminal 104 indicating to the computing instance 106 over the network 102 that the source text is already translated or the source text is in need of translation. For example, this indication may occur by the user operating the GUI (e.g., by operating or activating a checkbox, a dropdown menu, a dial, a button) displayed on the computing terminal 104. Note that there may be a default option preprogrammed or preselected, unless the user indicates otherwise. For example, the default option may be the source text needs a translation, as disclosed herein, unless the user indicates otherwise. For example, the default option may be the source text is already translated and needs to be augmented or adapted, as disclosed herein, unless the user indicates otherwise. As such, if the computing instance 106 determines that the user indicated (actively or passively through the default option) that the source text is already translated, then a transformation (e.g., augmentation, adaptation) workflow is performed, pursuant to Step 4 of the method 200. If the computing instance 106 determines that the user indicated (actively or passively through the default option) that the source text is in need of translation, then a translation workflow is performed, pursuant to Step 5 of the method 200. However, note that the computing instance 106 may determine whether the source text is translated or in need of translation based on an indicator present in the persona request received from the computing terminal 104 over the network 102 in Step 1 of the method 200. As such, this determination at Step 3 of the method 200 may be automated, without any manual input from the computing terminal 104 over the network 102 at that step.

Step 4 involves the computing instance 106 generating a transformation prompt, pursuant to the transformation workflow referenced in Step 3 of the method 200. The transformation prompt is generated based on the computing instance 106 executing various prompts received from the persona style guide, as referenced above in Steps 1-2 of the method 200, on the source text (or a copy thereof) that has been indicated to be already translated, by the user operating the computing terminal 104. For example, this execution may involve the computing instance 106 escaping (e.g., encoding) the source text, which is translated, to be appropriate (e.g., formatted) for the LM 114. For example, this execution may involve the computing instance 106 transforming the source locale ID, the translation locale ID, and the source text, as translated and escaped, into a target prompt for the LM 114. For example, this execution may involve the computing instance 106 combining the persona style guide prompts (as fetched pursuant to Step 2 of the method 200), a target prompt, and additional standardized transformation prompts to have a single transformation prompt to be executable by the LM 114. As such, for example, the computing instance 106 may generate a prompt (e.g., a text string) based on the persona, the descriptive attribute, and the stylistic preference to perform the conversion of the first text recited in the first language for the first region identifier to the second text recited in the second language for the second region identifier. The persona may be selected from a set of personas each associated with a respective descriptive attribute and a respective stylistic preference for the persona before the prompt is generated. The first text (e.g., the source text) may be output from an MT engine before the prompt is generated.

Step 5 involves the computing instance 106 generating a translation prompt, pursuant to the translation workflow referenced in Step 3 of the method 200. The translation prompt is generated based on the computing instance 106 executing various prompts received from the persona style guide, as referenced above in Steps 1-2 of the method 200, on the source text (or a copy thereof) that has been indicated to be in need of translation, by the user operating the computing terminal 104. For example, this execution may involve the computing instance 106 escaping (e.g., encoding) the source text to be appropriate (e.g., formatted) for the LM 114. For example, this execution may involve the computing instance 106 transforming the source locale ID, the translation locale ID, and the source text, as escaped, into a target prompt for the LM 114. For example, this execution may involve the computing instance 106 combining the persona style guide prompts (as fetched pursuant to Step 2 of the method 200), a target prompt, and additional standardized translation prompts to have a single translation prompt to be executable by the LM 114.

Step 6 involves the computing instance 106 inputting (e.g., submitting) a prompt (or a copy thereof), whether the single transformation prompt or the single translation prompt, into the LM 114, which may be over the network 102. For example, the computing instance 106 may utilize the set of LM provider credentials and metadata to input the prompt into the LM 114. For example, the computing instance 106 may use input the prompt into the LM 114 using the set of LM provider credentials and metadata, create an API request to the LM providers infrastructure with the prompt based on Step 4 or Step 5 of the method 200. The computing instance 106 inputs the prompt into the LM 114 such that the LM 114 outputs an output (e.g., a response) based on the prompt. For example, the output may include a text (e.g. an alphanumeric string), whether structured or unstructured, whether adapted or augmented from the source text, or translated from the source text, which may further include adaptation or augmentation from the source text, as disclosed herein. The computing instance 106 intakes (e.g., ingests, copies) the output, which may include storing the output within the computing instance 106. The computing instance 106 may unescape (e.g., decode) the output and clean the output with various techniques (e.g., formatting). As such, for example, the computing instance 106 may input the prompt into the LM 114 such that the LM 114 generates an output (e.g., a text string) containing the second text recited in the second language for the second region identifier. The LM may be a large LM or a small LM. The LM 114 may be internal to the computing instance 106 (e.g., for speed) or external to the computing instance 106 (e.g., for modularity). The computing instance 106 may input the prompt into the LM 114 via the chatbot 112. The chatbot 112 may be internal to the computing instance 106 (e.g., for speed) or external to the computing instance 106 (e.g., for modularity). The second text may be an unstructured text or a structured text.

Step 7 involves the computing instance 106 attempting to validate the output received in Step 6 of the method 200. The computing instance 106 may attempt to validate the output in various ways. For example, the computing instance 106 may determine if the output is valid by not being blank or purely whitespace. For example, the computing instance 106 may determine if the output is valid by being semantically similar to the source text, which may involve calculating various sentence embeddings between the source text and the output and then find a cosine similarity between various vectors to determine if the cosine similarity is within a certain threshold to be semantically similar (or dissimilar if not). For example, the computing instance 106 may determine if the output is valid by determining if a negative log likelihood satisfies (e.g., passes) a threshold, which may be based on an exponent of a summation of the negative log likelihood of the output (e.g., by tokens). Note that tokenization may include splitting a text into words or parts of a word in order to analyze, classify, and process the words to transform the text accordingly (such as with translation). As such, for example, the computing instance 106 may attempt to validate the output received from the LM 114. The output may be attempted to be validated based on determining whether the output is not blank or purely whitespace. The output may be attempted to be validated based on determining whether the output satisfies a threshold corresponding to a string length. The output may be attempted to be validated based on determining whether the second text satisfies the threshold corresponding to the string length. The output may be attempted to be validated based on determining whether the second text is semantically similar to the first text. The output may be attempted to be validated based on determining whether the second text is semantically similar to the first text based on (1) a sentence embedding between the first text and the second text, (2) a cosine similarity based on the sentence embedding, and (3) a presence of the cosine similarity within a range indicating the output to be valid. The output may be attempted to be validated based on a negative log likelihood.

Step 8 involves the computing instance 106 determining whether the output is validated based on Step 7 of the method 200. If yes, then Step 9 of the method 200 is performed. If no, then Step 10 of the method 200 is performed.

Step 9 involves the computing instance 106 taking an action (e.g., a first action), which may be responsive to the persona request being submitted from the computing terminal 104 to the computing instance 106 over the network 102 pursuant to Step 1 of the method 200. For example, the action may include enabling (e.g., serving) a presentation of a menu or a screen on the computing terminal 104 over the network 102, responsive to the persona request being submitted from the computing terminal 104 to the computing instance 106 over the network 102 pursuant to Step 1 of the method 200, where the menu or the screen indicates that the source text has been augmented or adapted, or translated, which may further include augmentation or adaptation. For example, the action may include sending the output (or a copy thereof), as validated, to the computing terminal 104 over the network 102, responsive to the persona request being submitted from the computing terminal 104 to the computing instance 106 over the network 102 pursuant to Step 1 of the method 200. For example, the output may be sent as a data file (e.g., a productivity suite file, a word processor file).

Step 10 involves the computing instance 106 taking an action (e.g., a second action), which may be responsive to the persona request being submitted from the computing terminal 104 to the computing instance 106 over the network 102 pursuant to Step 1 of the method 200. For example, the action may include enabling (e.g., serving) a presentation of a menu or a screen on the computing terminal 104 over the network 102, responsive to the persona request being submitted from the computing terminal 104 to the computing instance 106 over the network 102 pursuant to Step 1 of the method 200, where the menu or the screen indicates an error. For example, the error may indicate that the source text is invalid or otherwise improper or inappropriate for conversion (e.g., translation, augmentation, adaptation).

As such, for example, based on Steps 8-10 of the method 200, the computing instance 106 may take a first action responsive to the request (e.g., a persona request) based on the output being validated or a second action responsive to the request (e.g., a persona request) based on the output not being validated. The first action may be directed to or with respect with or configured for the computing terminal 104 (e.g., enable a menu or a screen to be presented indicating a conversion or a send a data file containing a text that has been converted). The second action may be directed to or with respect with or configured for the computing terminal 104 (e.g., enable a menu or a screen to be presented indicating an error in conversion). For example, the first action may be enabling the computing terminal 104 to display the second text responsive to the request. For example, the second action may be enabling the computing terminal 104 to display an error message responsive to the request.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, a chemical molecule, a chemical composition, or any suitable combination or equivalent of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

What is claimed is:

1. A system, comprising:
a computing instance programmed to:
store a persona, a descriptive attribute for the persona, and a stylistic preference for the persona;
receive a request from a computing terminal, wherein the request requests a conversion of a first text recited in a first language for a first region identifier to a second text recited in a second language for a second region identifier;
generate a prompt based on the persona, the descriptive attribute, and the stylistic preference to perform the conversion of the first text recited in the first language for the first region identifier to the second text recited in the second language for the second region identifier;
input the prompt into a language model (LM) such that the LM generates an output containing the second text recited in the second language for the second region identifier;
attempt to validate the output; and
take a first action responsive to the request based on the output being validated or a second action responsive to the request based on the output not being validated.

2. The system of claim 1, wherein the persona stores the stylistic preference.

3. The system of claim 1, wherein the persona stores the descriptive attribute and the stylistic preference.

4. The system of claim 1, wherein the first language and the second language are one language.

5. The system of claim 1, wherein the first language and the second language are different languages.

6. The system of claim 1, wherein the first region identifier and the second region identifier are one region identifier.

7. The system of claim 1, wherein the first region identifier and the second region identifier are different region identifiers.

8. The system of claim 1, wherein the persona is selected from a set of personas each associated with a respective descriptive attribute and a respective stylistic preference for the persona before the prompt is generated.

9. The system of claim 1, wherein the output is attempted to be validated based on determining whether the output is not blank or purely whitespace.

10. The system of claim 1, wherein the output is attempted to be validated based on determining whether the output satisfies a threshold corresponding to a string length.

11. The system of claim 10, wherein the output is attempted to be validated based on determining whether the second text satisfies the threshold corresponding to the string length.

12. The system of claim 1, wherein the output is attempted to be validated based on determining whether the second text is semantically similar to the first text.

13. The system of claim 12, wherein the output is attempted to be validated based on determining whether the second text is semantically similar to the first text based on (1) a sentence embedding between the first text and the second text, (2) a cosine similarity based on the sentence embedding, and (3) a presence of the cosine similarity within a range indicating the output to be valid.

14. The system of claim 1, wherein the output is attempted to be validated based on a negative log likelihood.

15. The system of claim 1, wherein the conversion includes a translation of the first text recited in the first language for the first region identifier to the second text recited in the second language for the second region identifier.

16. The system of claim 1, wherein the conversion includes an augmentation or an adaptation of the first text recited in the first language for the first region identifier to the second text recited in the second language for the second region identifier.

17. The system of claim 1, wherein the first text is output from a Machine Translation (MT) engine before the prompt is generated.

18. A method, comprising:
storing, via a computing instance, a persona, a descriptive attribute for the persona, and a stylistic preference for the persona;
receiving, via the computing instance, a request from a computing terminal, wherein the request requests a conversion of a first text recited in a first language for a first region identifier to a second text recited in a second language for a second region identifier;
generating, via the computing instance, a prompt based on the persona, the descriptive attribute, and the stylistic preference to perform the conversion of the first text recited in the first language for the first region identifier to the second text recited in the second language for the second region identifier;
inputting, via the computing instance, the prompt into a language model (LM) such that the LM generates an output containing the second text recited in the second language for the second region identifier;
attempting, via the computing instance, to validate the output; and
taking, via the computing instance, a first action responsive to the request based on the output being validated or a second action responsive to the request based on the output not being validated.

19. A storage medium storing a set of instructions executable by a computing instance to perform a method, wherein the method comprising:
storing, via a computing instance, a persona, a descriptive attribute for the persona, and a stylistic preference for the persona;
receiving, via the computing instance, a request from a computing terminal, wherein the request requests a conversion of a first text recited in a first language for a first region identifier to a second text recited in a second language for a second region identifier;
generating, via the computing instance, a prompt based on the persona, the descriptive attribute, and the stylistic preference to perform the conversion of the first text recited in the first language for the first region identifier to the second text recited in the second language for the second region identifier;
inputting, via the computing instance, the prompt into a language model (LM) such that the LM generates an output containing the second text recited in the second language for the second region identifier;
attempting, via the computing instance, to validate the output; and
taking, via the computing instance, a first action responsive to the request based on the output being validated or a second action responsive to the request based on the output not being validated.

20. A system, comprising:
a computing instance programmed to:
store a persona, a descriptive attribute for the persona, and a stylistic preference for the persona;
receive a request from a data source, wherein the request requests a conversion of a first text recited in a first language for a first region identifier to a second text recited in a second language for a second region identifier;
generate a prompt based on the persona, the descriptive attribute, and the stylistic preference to perform the conversion of the first text recited in the first language for the first region identifier to the second text recited in the second language for the second region identifier;
input the prompt into a language model (LM) such that the LM generates an output containing the second text recited in the second language for the second region identifier;
attempt to validate the output; and
take a first action responsive to the request based on the output being validated or a second action responsive to the request based on the output not being validated.
